(19) United States
(12) Patent Application Publication
(10) Pub. No.: US 2024/0118195 A1
(43) Pub. Date: Apr. 11, 2024

(54) COMPONENT CONCENTRATION MONITORING APPARATUS AND METHOD

(71) Applicant: Design PDV LLC, Charlotte, NC (US)

(72) Inventor: Roderick M. Dayton, Charlotte, NC (US)

(21) Appl. No.: 18/378,532

(22) Filed: Oct. 10, 2023

Related U.S. Application Data
(60) Provisional application No. 63/414,714, filed on Oct. 10, 2022.

(51) Int. Cl. G01N 21/33

(52) U.S. Cl. CPC G01N 21/33

(57) ABSTRACT

An apparatus that monitors a concentration of a sanitizer is provided. The apparatus includes a housing that defines a fluid passage and encloses an onboard power source. A light source supported by the housing is to be energized by the onboard power source to emit light that is at least partially attenuated by the sanitizer in the sanitizing composition. A light sensor separated from the light source by the fluid passage senses the light transmitted by the light source that has been at least partially attenuated by the sanitizer composition within the fluid passage and transmits a signal indicative of the sensed light. Electronic control circuitry converts the signal into a sensed concentration of the sanitizer in the sanitizer composition and an alert system is activated by the electronic control circuitry to issue a notification that conveys information about the sensed concentration of the sanitizer.

### BACKGROUND OF THE INVENTION

### 1. Field of the Invention

This application relates generally to a method and apparatus for monitoring a concentration of a component included in a liquid medium and, more specifically, to a method and apparatus for detecting when a concentration of a disinfectant within a liquid medium falls outside of a defined range of concentrations.

### 2. Description of Related Art

Commercial kitchens may include a multi-sink (e.g., three-sink) cleansing station used to clean wares such as plates, silverware, cooking utensils, etc. A first sink bay, also referred to as a “wash sink,” can be at least partially filled with hot water including a detergent. Dirty wares are introduced to the water in the first sink bay and scrubbed as part of a cleansing operation. A second sink bay, also referred to as a “rinse sink,” stores warm water. Wares that have been washed in the first sink bay are transferred to the second sink bay and introduced to the warm water therein to be rinsed. The third sink bay, also referred to as a “sanitize sink,” stores a sanitizing composition comprising water mixed with a sanitizer that is food-contact safe. After being rinsed, the wares are transferred to the third sink bay and submerged in the sanitizing composition for a length of time to limit the presence of pathogens on the wares and the possibility of exposing diners to those pathogens.

To be effective, the concentration of the sanitizer in the sanitizing composition is to be maintained within an approved range of concentrations. But the approved range of concentrations can vary depending on factors such as the type of sanitizer, the temperature of the water in the sanitizing composition, the length of time that the wares will remain submerged in the sanitizing composition, local ordinances, etc. Further, conventional tests of the concentration of the sanitizer often require the tester to sample the sanitizing composition, under specific test conditions, and make a judgement when interpreting the results. As a result, ensuring that the concentration of the sanitizer in the sanitizing composition is suitable for a specific sink installation and cleansing operation is complex, open to bias resulting from the interpretation of test results by different observers, and time consuming. Such drawbacks may also limit how often busy kitchen personnel devote the time required to conduct conventional tests.

### BRIEF SUMMARY OF THE INVENTION

Accordingly, there is a need in the art for a method and apparatus for monitoring a concentration of a sanitizer in a sanitizing composition in real time, optionally used for sanitizing wares in a food service environment. According to some embodiments, the method and apparatus involve the use of a light source to emit light that exhibits a response based on a concentration of the sanitizer as the light passes through a liquid sanitizing composition. A quality such as measured attenuation of the emitted light is detected by a sensor spaced a defined distance from the light source. Electronic circuitry is configured to receive a signal transmitted by the sensor indicative of the measured attenuation, and convert the received signal into a concentration value of the sanitizer in the sanitizing composition. Based on the concentration value, the electronic circuitry controls operation of a visible, audible, or combination visible and audible indicator to indicate whether the concentration value falls within, or outside of a suitable range for sanitizing wares for food service.

According to one aspect, the subject application involves an apparatus that monitors a concentration of a sanitizer in a liquid sanitizing composition used to sanitize wares for food service. The apparatus includes a housing that defines a fluid passage that receives the sanitizing composition when the apparatus is at least partially submerged in the sanitizing composition, and an onboard power source supported by the housing that supplies electric energy. A light source supported by the housing is to be energized by the electric energy supplied by the onboard power source to emit light that is attenuated by the sanitizer in the sanitizing composition. A light sensor supported by the housing a fixed distance from the light source, at a position separated from the light source by the fluid passage, that senses the light transmitted by the light source that has been at least partially attenuated by the sanitizer composition within the fluid passage and transmits a signal indicative of the sensed light. Electronic control circuitry operatively connected to the light sensor receives the signal and converts the signal into a sensed concentration of the sanitizer in the sanitizer composition. According to some embodiments, an alert system is activated by the electronic control circuitry to issue a notification that conveys information about the sensed concentration of the sanitizer. For example, the notification can include at least one of a visible notification and an audible notification.

According to another aspect, the subject application involves a sink that includes a sink bay including a sink bottom and a perimeter extending about a periphery of the sink bottom to form a basin that retains a liquid sanitizing composition. A drain can be formed in the sink bottom through which the liquid sanitizing composition is to be drained from the basin. An apparatus that monitors a concentration of a sanitizer in the liquid sanitizing composition can be supported by a surface forming a portion of at least one of the sink bottom and the perimeter. The apparatus can include a light source that emits light attenuated by the sanitizer in the sanitizing composition through a portion of the basin. A light sensor separated from the light source by the portion of the basin forms a fluid passage between the light sensor and the light source. The light sensor senses light at least partially attenuated by the sanitizer composition within the fluid passage and transmits a signal indicative of the attenuation of the light sensed. Electronic control circuitry operatively connected to the light sensor receives the signal and converts the signal into a sensed concentration of the sanitizer in the sanitizer composition, and activates an alert system. The alert system, in response to being activated, issues a notification that conveys information about the sensed concentration of the sanitizer, wherein the notification comprises at least one of a visible notification and an audible notification.

According to another aspect, the subject application involves a method of monitoring a concentration of a sanitizer in a liquid sanitizing composition used to sanitize wares for food service. For example, the method can include emitting, with a light source, light that is attenuated by the sanitizer into the sanitizing composition disposed in a sink. With a light sensor, attenuation of the light by the sanitizer composition is sensed and a signal indicative of the attenuation of the light is transmitted. Electronic control circuitry in communication with the light sensor converts the signal into a sensed concentration of the sanitizer in the sanitizer composition, and an alert system, issues a notification that conveys information about the sensed concentration of the sanitizer. The notification can include at least one of a visible notification and an audible notification.

According to another aspect, the subject application involves a method of monitoring, with an electronic monitoring apparatus, a concentration of a sanitizer in a liquid sanitizing composition used to sanitize wares for food service. Embodiments of the method include at least partially submerging the electronic monitoring apparatus in the liquid sanitizing composition in a basin of a sink. Light emitted by a light source of the electronic monitoring apparatus is: (i) transmitted through the liquid sanitizing composition, (ii) attenuated by the sanitizer included in the liquid sanitizing composition, and (iii) sensed by a light sensor provided to the electronic monitoring apparatus. A notification issued by an alert system of the electronic monitoring apparatus is observable to determine a concentration status of the sanitizer in the liquid sanitizer composition.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an illustrative embodiment of a multi-sink cleansing station comprising a plurality of sink basins in which wares for food service can be cleaned and sanitized according to aspects of the present disclosure;

FIG. 2 is a top view into an illustrative embodiment of a sink basin according to aspects of the present disclosure;

FIG. 3 is a perspective view of an illustrative embodiment of an apparatus for monitoring a concentration of a sanitizer in a liquid sanitizing composition according to aspects of the present disclosure;

FIG. 4 shows a schematic, side view of an apparatus for monitoring a concentration of a sanitizer in a liquid sanitizing composition, resting on a sink bottom and submerged within a liquid sanitizing composition according to aspects of the present disclosure;

FIG. 5 is perspective view of an illustrative embodiment of a drainage system that can be positioned in a drain of a sink basin, the drainage system being in a stopped state;

FIG. 6 is perspective view of the illustrative embodiment of the drainage system in FIG. 5, in an evacuation state;

FIG. 7 is a flow diagram schematically depicting steps in an illustrative embodiment of a process for monitoring a concentration of a sanitizer in a liquid sanitizing composition according to aspects of the present disclosure;

FIG. 8 is a flow diagram schematically depicting steps in an illustrative embodiment of such a control method for monitoring the concentration of a sanitizer in a liquid sanitizing composition;

FIG. 9 is a perspective view of a multi-sink cleansing station including an apparatus for monitoring a concentration of a sanitizer in a liquid sanitizing composition, where a portion of the apparatus forms a portion of the multi-sink cleansing station;

FIG. 10 is a perspective view of an embodiment of an apparatus for monitoring a concentration of a sanitizer in a liquid sanitizing composition, the apparatus including a pump to introduce the sanitizer to the liquid sanitizing composition;

FIG. 11 is a partially cutaway view showing components of the apparatus shown in FIG. 10, with an upper portion of a housing removed; and

FIG. 12 is a flow diagram schematically depicting steps in an illustrative embodiment of a control method for monitoring the concentration of a sanitizer in a liquid sanitizing composition having reduced optical clarity.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

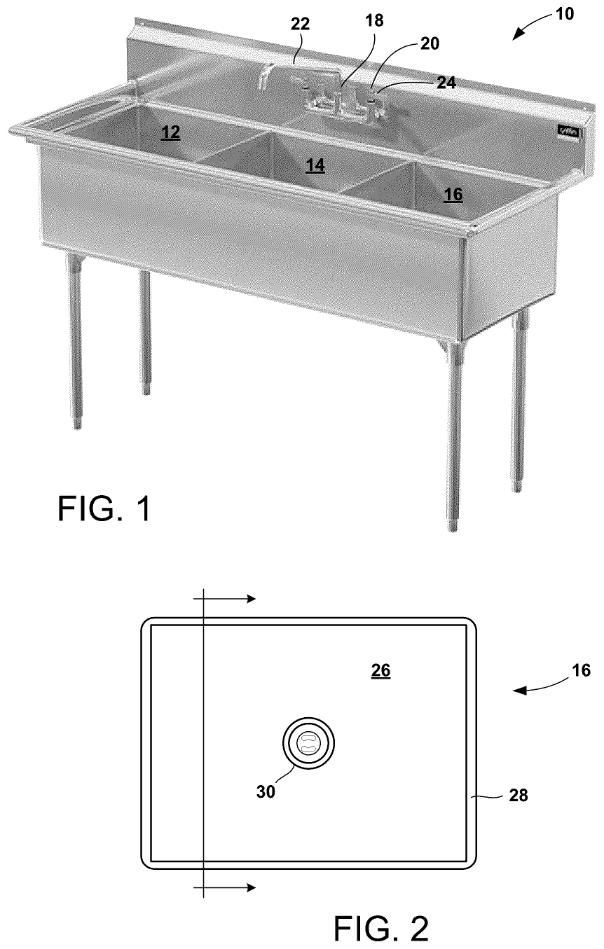

FIG. 1 shows an illustrative embodiment of a multi-sink cleansing station 10 comprising a plurality of sink basins 12, 14, 16 in which wares for food service can be cleaned and sanitized. The sink basins 12, 14, 16 can optionally be integrally formed as sink bays for cleaning and sanitizing wares for food service, making up parts of a common, monolithic structure or forming separate and independent structures. At least one faucet 18 is in fluid communication with a water source such as a pipe that conveys water from a public utility, private water supply, well or any other supply of water. The faucet 18 can include one, or a plurality of control valves 20 that regulate the flow of water from the supply, through a spout 22 and into one or more of the sink basins 12, 14, 16. For embodiments with a single control valve 20, a single handle 24 can be manipulated by a user two vary the temperature of water being introduced to the sink basins 12, 14, 16. According to alternate embodiments that include a plurality of control valves 20, a handle 24 dedicated to each control valve 20 can be separately manipulated to control the flow of water at different temperatures into the sink basins 12, 14, 16.

A top view looking down into an embodiment of the sink basin 16 is shown in FIG. 2. The sink basin 16 will be described as forming a sanitizing bay in FIG. 2, and includes a sink bottom 26 and a perimeter wall 28 extending about a periphery of the bottom 26 to form the basin 16 that retains a liquid sanitizing composition. The bottom 26 can be tapered towards a drain 30 formed in the bottom 26 through which a liquid sanitizing composition can flow from the sink basin 16.

When used in a food service environment such as a restaurant, for example, the sink basins 12, 14, 16 can be used during a series of steps to cleanse and sterilize wares such as eating utensils, plates, cups, etc. used to serve food and/or drinks. For example, the first sink basin 12 can contain soapy water, the second sink basin 14 can contain rinse water and the third sink basin 16 can contain a liquid sanitizing composition including a sanitizer in a concentration suitable for sanitizing wares used in food service. According to some embodiments, the sanitizer can include a quaternary ammonium compound (“quat”) diluted to a concentration suitable for sanitizing wares, but other food-safe sanitizers are also within the scope of the present disclosure. A suitable concentration of the quat can fall within a range approved by a governing regulatory body as achieving a desired level of sanitization of the wares without posing a toxic threat to diners eating from such wares. For example, the range can include the quat present in concentrations from about 200 ppm to about 400 ppm, or from about 180 ppm to about 420 ppm, or from about 200 ppm to about 300 ppm, or any other range of desired concentrations. A plate, for example, can be placed in the first sink basin 12 and washed, before being transferred to the second sign basin 14 to be rinsed. After rinsing, the plate is submerged in the liquid sanitizing composition contained in the third sink basin 16 to be sanitized. As the plate and other wares are submerged in the liquid sanitizing composition, residual water on the plate and other wares dilutes the concentration of the quat in the liquid sanitizing composition.

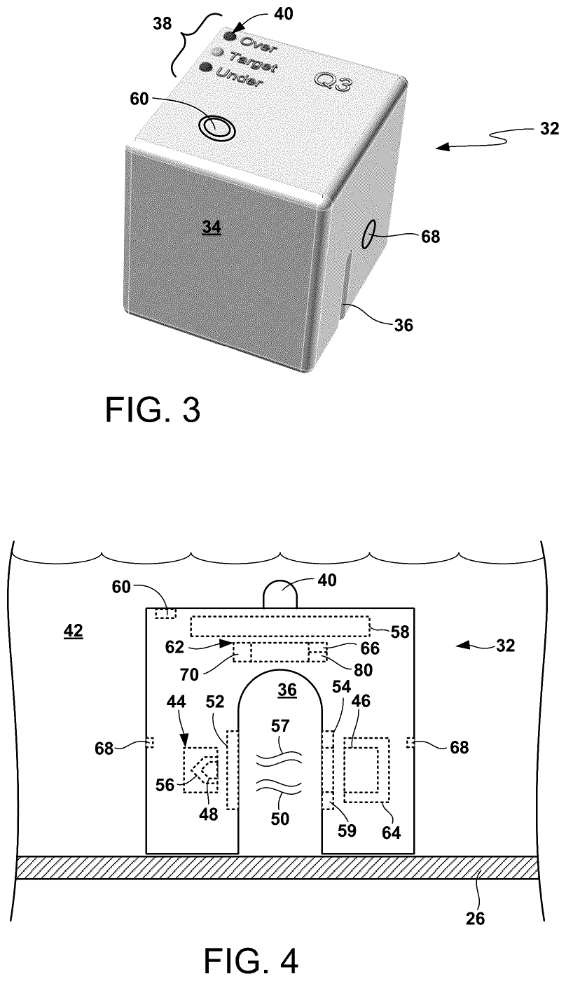

FIG. 3 shows an illustrative embodiment of an apparatus 32 for monitoring a concentration of a sanitizer in a liquid sanitizing composition. As shown, the apparatus 32 includes a housing 34 that forms a water-tight compartment. The housing 34 can also define a fluid passage 36 that receives the sanitizing composition when the apparatus 32 is at least partially submerged in the sanitizing composition. The apparatus 32 senses the attenuation of light contributed by, at least in part, the sanitizer component of the liquid sanitizing composition received in the fluid passage 36, and converts that attenuation into a sensed concentration of the sanitizer. Based on the sensed concentration, an alert system 38 provided to the housing 34 is activated to issue a notification that conveys information about the sensed concentration of the sanitizer.

According to some embodiments, the alert system 38 can include a LED module 40 comprising a single LED, a plurality of LEDs, or any other illumination device that can be selectively activated to convey information about the sensed concentration of the sanitizer in the liquid sanitizing composition. For example, the LED module 40 can include a single LED, that can be monochromatic or multi-color to emit different colors of light to indicate different sensed concentrations of the sanitizer. According to such embodiments, a multi-color LED can be illuminated to emit red light to indicate that the sensed concentration of the sanitizer has exceeded an upper threshold defining a high-end of a range of acceptable values (e.g., 180 ppm-420 ppm, or 200 ppm-400 ppm, or 180 ppm-300 ppm, or 200-300 ppm, etc.). The multi-color LED can be illuminated to emit green light to indicate that the sensed concentration of the sanitizer is within an acceptable range of sensed concentration values. The multi-color LED can again be illuminated to emit red light or a different color (e.g., orange) of light to indicate that the sensed concentration of the sanitizer is less than a lower threshold defining a low-end of a range of acceptable values. If red light is also used to indicate that the sensed concentration is less than the lower threshold, the red light can optionally be repeatedly flashed on and off to distinguish this condition from the sensed concentration exceeding the upper threshold.

According to other embodiments, the LED module 40 includes a plurality of discrete LEDs, each being illuminated to convey different information about the sensed concentration of the sanitizer. For the embodiment of the LED module 40 shown in FIG. 3, three LEDs are arranged to be illuminated to indicate that the sensed concentration of the sanitizer exceeds an upper threshold (labeled “Over”), is on target or within an acceptable range of concentrations (labeled “Target”), or is below a lower threshold (labeled “Under”).

The alert system 38 can optionally be configured to issue a visible notification that notifies an observer that the concentration of the sanitizer in the liquid sanitizing composition approaches an upper limit, a lower limit, or both the upper limit and the lower limit of a range of acceptable concentrations. Referring again to the example of sanitizing wares for food service, as dishes are placed in the sink basin 16 the concentration of the quat can be diluted by residual water on the dishes. For embodiments with 200 ppm of the quat established as the lower limit of the range of acceptable concentrations, the alert system 38 can issue a visible and/or audible notification that the sensed quat concentration has dropped to 220 ppm. Upon observing such a notification, the observer can introduce a quantity of the quat to the sanitizing composition to increase the sensed concentration of the quat closer to the middle of the acceptable range, or closer to the upper limit of the acceptable range for example.

Although the alert system 38 is shown in FIG. 3 as being supported by the housing 34, the present disclosure is not so limited. According to some embodiments, the alert system 38, or a portion thereof, can be remote from and independently positioned relative to the housing 34. The remote portion of the alert system 38 is operatively connected to the apparatus 32 to receive a control signal that controls activation of the remotely-located portion of the alert system 38. For example, the remotely-located portion of the alert system 38 can be configured and/or operable similar to the alert system 38 provided to the housing 34 as described herein. The apparatus 32 can issue the control signal that can be transmitted by a transmitter disposed within the housing 34 via a wired or wireless communication channel to the remotely-located portion of the alert system 38, causing the alert system 38 to issue any of the notifications described herein. Alternate embodiments of the transmitter can optionally transmit data pertaining to at least one of: (i) one or more parameters sensed by the apparatus 32, (ii) one or more notifications issued by the apparatus 32, (iii) one or more control signals or other signals transmitted by the apparatus 32 or a component thereof, and (iv) any other operational information. For example, the transmitter of the apparatus can be operatively connected to an Internet of Things (“IoT”) portal over a wired or wireless network communication channel. The transmitted data can optionally be used for documenting compliance with applicable standards, rules and/or regulations, to obtain information about products and/or services used by an entity, etc.

In addition to, or instead of the visible notifications described above, the alert system 38 can include a speaker or other broadcast device, coupled to the housing 34 or remote and independent of the housing 34, that issues an audible notification. The audible notification can include an alarm that is periodically broadcast within the vicinity of the multi-sink cleansing station 10, for example.

It is to be understood that the examples provided herein are not exhaustive of the configurations of the alert system 38. Instead, one or more LED modules 40 including a single LED, a plurality of LEDs, or one or more other types of indicator(s) that are visible to an observer can be controlled in any manner to convey information about a plurality of different sensed concentrations of the sanitizer. Issuing notifications including colors of light, flashes of light, audible sounds and other examples described herein are merely examples and not limiting on the scope of the present disclosure.

FIG. 4 shows a schematic, side view of an embodiment of the apparatus 32 for monitoring the concentration of the sanitizer in the liquid sanitizing composition 42. As shown in FIG. 4, the apparatus 32 is resting on a sink bottom 26 and fully submerged within a liquid sanitizing composition 42, however at least a portion of the apparatus 32 is to be submerged in the liquid sanitizing composition 42 to monitor the sanitizer concentration as described herein. The fluid passage 36 defined by the housing 34 of the present embodiment extends entire through the housing 34, allowing the liquid sanitizing composition 42 to flow through the housing 34 as the liquid sanitizing composition 42 is agitated. Agitation can occur as a result of the wares being placed in the liquid sanitizing composition 42, operation of a mixer, etc. But regardless of the source, agitation improves the homogeneity of the sanitizer in the liquid sanitizing composition 42.

A light source 44 and a light sensor 46 are also supported within the housing 34, and are shown as hidden lines in FIG. 4. The light source 44 and light sensor are arranged a fixed distance apart so the light sensor 46 measures a quality and/or quantity of the liquid sanitizing composition 42 based on an effect of the liquid sanitizing composition 42 on light emitted by the light source 44.

For example, the light source 44 can optionally include an ultraviolet LED emitter 48 that emits ultraviolet-C (“UVC”) light 50, having a wavelength within a range from about 200 nm to about 300 nm. The UVC light 50 is transmitted through a first shield 52 arranged adjacent to the light source 44. The first shield 52 can form a portion of the housing 34 that defines a portion of the fluid passage 36, allowing the UVC light 50 to exit the housing 34 and pass through the liquid sanitizing composition 42 within the fluid passage 36. It is believed that UVC light 50 is attenuated by sanitizer such as the quat, but is not attenuated by the liquid medium in which the quat is diluted, such as pure water for example. Accordingly, the attenuation of the UVC light 50 sensed by the light sensor 46 and electronic control circuitry 62 (FIG. 4) herein is attributed primarily to the attenuation caused by the sanitizer in the liquid sanitizing composition 42. Accordingly, the electronic control circuitry 62 can be configured to control the light source 44 to emit UVC light 50, for example, having a known radiant intensity, luminous intensity, or other parameter. The parameter of the UVC light 50 passing through the liquid sanitizing composition 42 can then be sensed by the light sensor 46. The electronic control circuit 62 can determine the extent to which the parameter was attenuated as a result of the UVC light 50 passing through the liquid sanitizing composition 42 and use that attenuation result to determine the sensed concentration of the sanitizer in the liquid sanitizing composition 42.

According to some embodiments, the light source 44 can also optionally include a second emitter 56 that emits light having a second wavelength outside of the range from about 200 nm to about 300 nm. For example, the second emitter 56 can emit ultraviolet-A (“UVA”) light 57 having a wavelength from about 315 nm to about 400 nm. The light emitted by the second emitter 56 can interact with the sanitizer in the liquid sanitizing composition 42 in a different manner than the UVC light 50 interacts with the sanitizer in the liquid sanitizing composition 42 to allow the electronic control circuitry 62 to determine the sanitizer concentration.

For example, transmission of the UVC light 50 through a liquid sanitizing composition 42 having high (e.g., greater than 300 ppm, or greater than 350 ppm, or greater than 400 ppm, etc.) is believed to cause the quat in the liquid sanitizing composition 42 to fluoresce, thereby negatively affecting the optical clarity of the liquid sanitizing composition 42. As another example, the liquid sanitizing composition 42 can be contaminated with one or more contaminants such as soap transported to the sink basin 16 on wares that have been washed, which can also negatively affect the optical clarity of the liquid sanitizing composition 42. Under such circumstances involving negatively-affected optical clarity of the liquid sanitizing composition 42, using the sensed attenuation or other parameter of the UVC light 50, alone, can cause the electronic control circuitry 62 to determine a false, high sanitizer concentration. The false, high sanitizer concentration determined by the electronic control circuitry 62 is expected to be higher than the actual concentration of the sanitizer in the liquid sanitizing composition 42 because the fluorescence of the quat and/or the presence of a contaminant contributes to the attenuation of the UVC light 50. However, it is believed that light such as the UVA light 57 is less susceptible to the fluorescence of the quat and/or contaminant in the liquid sanitizing composition 42 than the UVC light 50. Accordingly, the sensed attenuation or other parameter of light emitted by the second emitter 56 and transmitted through the liquid sanitizing composition 42 can be used by the electronic control circuitry 62 to more-reliably determine the sanitizer concentration under low optical clarity conditions than using the sensed attenuation or other parameter of the UVC light 50 alone.

Similarly, on an opposite side of the fluid passage 36 from the light source 44, the light sensor 46 can be protected against exposure to the liquid sanitizing composition 42 within the fluid passage 36 by a second shield 54. Like the first shield 52, the second shield 54 can optionally be arranged within an aperture in the housing 34, and form a portion of the housing 34 that defines a portion of the fluid passage 36. Accordingly, the first shield 52 and the second shield 54 form ports in the housing 34 through which the UVC light 50 emitted by the ultraviolet emitter 48 respectively exists and enters the housing 34 to pass through the liquid sanitizing composition 42 within the fluid passage 36. According to other embodiments, however, a majority or all of the housing 34 can be formed from the material of the first shield 52 and the second shield 54, avoiding the need to seal an interface between a separate first shield 52 and/or second shield 54 coupled to an embodiment of the housing 34 formed from a different material.

The first shield 52 and the second shield 54 can be formed from a material such as, for example, a polymeric composition (e.g., acrylic or silicone), a ceramic/glass material (e.g., quartz or fused silica), a specialized UV glass, etc. that is substantially transparent to the UVC light 50. According to other embodiments, the material of the first shield 52 and the second shield 54 can be formed from a material that is partially (but not entirely) opaque to UVC light 50. For such embodiments, the degree of opacity and the resulting attenuation of the UVC light 50, for example, can be factored into a control routine executed to relate a sensed quantity/quality of the UVC light 50 to a concentration of the sanitizer in the liquid sanitizing composition 42 as described herein. Yet other embodiments of the first shield 52 and/or the second shield 54 can optionally include a region 59 that filters a portion of the at least one of the UVC light 50 and the UVA light 57. For example, the region 59 can be formed from a material such as a yellow polymeric material that filters a portion of, but less than all wavelengths within the ultraviolet-A spectrum. It is believed that the region 59 can filter at least some of the fluorescence exhibited by the quat in response to being exposed to the UVC light 50 and/or UVA light 57, for example, which would limit the interference that would otherwise be caused by such fluorescence in determining the sensed concentration of the sanitizer.

According to some embodiments, the light sensor 46 senses the attenuation of the UVC light 50 by the liquid sanitizer composition 36 within the fluid passage 36, and transmits a signal indicative of the sensed attenuation. For example, the light sensor 46 can include a photodiode, photoresistor or any other light-sensitive component to measure the intensity of light within the ultraviolet-C spectrum, total radiation, or any other parameter of the UVC light 50 emitted by the light source 44. The sensed parameter of the UVC light 50 is converted by the light sensor 46 into a signal that is transmitted to electronic control circuitry 62 within the housing 34 that is operatively connected to receive signals from the light sensor 46.

For embodiments that include the second emitter 56, a second light sensor 64 can be operatively connected to the electronic control circuitry 62 within the housing 34. The second light sensor 64 can include a photodiode, photo resistor or any other light-sensitive component that converts sensed light emitted by the second emitter 56 into a signal to be transmitted to the electronic control circuitry 62. Referring again to the example involving the second emitter 56 emitting UVA light 57, the second light sensor 64 can sense an effect that the liquid sanitizing composition 42 in the fluid passage 36 has on the UVA light 57, and transmit a signal indicative of that effect. Examples of the parameter sensed by the second light sensor 64 include, but are not limited to the intensity, total radiation, etc. of the UVA light 57. Based on the signal transmitted by the second light sensor 64, the electronic control circuitry can determine when a contaminant is present in the liquid sanitizing composition 42 as described herein.

An onboard power source 58 can be supported by, and optionally enclosed within the housing 34 to supply electric energy that energizes other components of the apparatus 32. For example, the power source 58 can energize the light source 44 and/or light sensor 46 to cause the light source to emit the UVC light 50 or light having a different wavelength. Examples of the power source 58 include, but are not limited to alkaline batteries, a lithium-ion battery, or any other disposable or rechargeable source of electric energy. According to alternate embodiments, the power source 58 can receive electric energy from a remote source such as an ac mains wall outlet, for example. But including the power source 58 onboard the apparatus 32, within the housing 34, makes such embodiments of the apparatus 32 a wholly-contained, modular system. The system can be deployed simply by placing the apparatus 32 within the sink basin 16, at least partially submerged in the liquid sanitizing composition 42, and activating the apparatus 32.

At least partially submerging the apparatus 32 in the liquid sanitizing composition 42 involves adding the liquid sanitizing composition 42 while the apparatus 32 is in the sink basin 16, placing the apparatus 32 in the sink basin 16 containing the liquid sanitizing composition 42, or a combination thereof. The housing 34 does not necessarily need to be entirely submerged in the liquid sanitizing composition 42, although that is possible for embodiments with a liquid-tight housing 34. Instead, a suitable portion of the housing 34 is to be submerged in the liquid sanitizing composition 42 so light emitted by the light source, such as UVC light 50 emitted by the ultraviolet emitter 48 for example, is transmitted through the liquid sanitizing composition 42 in the fluid passage 36 before being received by the light sensor 46.

The apparatus 32 can optionally include a push button, toggle switch, or other suitable input device 60 (FIGS. 1 and 2) that can be manually manipulated by a user to activate the apparatus 32 and begin monitoring the sanitizer concentration in the liquid sanitizing composition 42. The input device 60 can be waterproof, preventing the intrusion of the liquid sanitizing composition 42 into the housing 34 through the input device 60 and the interface between the input device 60 and the housing 34. For such embodiments, the apparatus 32 can be deployed by placing the apparatus 32 within the sink basin 16, at least partially submerging the housing 34 in the liquid sanitizing composition 42, and manipulating the input device 60 (e.g., by pushing a pushbutton) to activate the apparatus 32.

According to alternate embodiments, the apparatus 32 can optionally include a fluid-activated switch 66 operatively connected to a pair of electrodes 68. When the liquid sanitizing composition 42 submerges a suitable portion of the housing 34 the level of the liquid sanitizing composition 42 is above the electrodes 68, thereby establishing a conductive pathway between the electrodes 68. The apparatus 32 can optionally be automatically activated in response to the conductive pathway between the electrodes 68 being established, such as when the apparatus 32 is placed in the sink basin 16 containing a suitable depth of the liquid sanitizing composition 42. Automatic activation of the apparatus 32 can be accomplished without manual user manipulation of a start button or other input device 60, for example, or without requiring the user to take any action other than placing the apparatus 32 in the liquid sanitizing composition 42 of a suitable depth. Similarly, when the apparatus 32 is removed from the liquid sanitizing composition 42 or the level of the liquid sanitizing composition 42 in the sink basin 16 falls below the level of the electrodes 68, the conductive pathway is no longer established, and the apparatus 32 can optionally be deactivated automatically.

According to some embodiments, at least one of the electrodes 68 can be provided to the housing 34 at a vertical elevation (when the housing 34 is upright, meaning the fluid passage 36 is positioned adjacent to a bottom of the housing 34) such that it will be submerged after, or contemporaneously with liquid sanitizing composition 42 submerging the fluid passage 36. In other words, when the liquid sanitizing composition 42 is at a depth sufficient to submerge both electrodes 68, the liquid sanitizing composition 42 is also sufficiently deep to submerge the fluid passage so the UVC light 50, for example, passes through the liquid sanitizing composition 42 before being sensed by the light sensor 46.

The fluid-activated switch can activate the apparatus 32 and commence monitoring of the sanitizer concentration in the liquid sanitizing composition 42 in response to the conductive pathway being established between the electrodes 68. Examples of the fluid-activated switch 66 include a semiconductor-based switching component, a discrete logic controller, and any other suitable switching device responsive to the presence of the liquid sanitizing composition 42 between the electrodes 68.

According to other embodiments, the fluid-activated switch 66 can simply include an electric circuit that is connected to a positive terminal of the power source 58 and a negative terminal of the power source 58, but is normally open in the absence of the conductive pathway between the electrodes 68. When the liquid sanitizing composition 42 rises sufficiently to submerge both electrodes 68, the liquid sanitizing composition 42 can create a short between the electrodes 68, thereby closing the circuit, causing electricity to be supplied by the power source 58 to the other components, activating the apparatus 32 and commencing monitoring.

The electronic control circuitry 62 is operatively connected to at least the light sensor 46, and optionally to the second light sensor 64, to receive the signals transmitted thereby. The electronic control circuitry 62 converts a signal transmitted by the light sensor 46 into a sensed concentration of the sanitizer in the liquid sanitizing composition 42. Similarly, the electronic control circuitry 62 also converts a signal transmitted by the second light sensor 64 into a sensed concentration of the sanitizer in the liquid sanitizing composition 42, based on a different interaction between the light emitted by the second emitter 56. The sensed concentrations determined based on the signal transmitted by the light sensor 46 and the signal transmitted by the second light sensor 64 can optionally both be used to control operation of the alert system 38 to notify an observer of an excessive sanitizer concentration.

Some embodiments of the electronic control circuitry 62 include a timer circuit 70. The timer circuit 70 can transmit a signal at defined intervals, or after expiration of a defined period of time. For example, the timer circuit 70 can transmit an expiration signal in response to expiration of a period of time (e.g., 2 hours, 3 hours, 4 hours, 5 hours, etc.) during which the liquid sanitizing composition 42 is considered usable to comply with regulations governing the sanitary conditions in the food service industry. As another example, the timer circuit 70 can transmit an expiration signal in response to regular periodic intervals (e.g., every minute, every 2 minutes, every 4 minutes, every 6 minutes, every 8 minutes, every 10 minutes, etc.) at which times the concentration of the liquid sanitizing composition 42 is to be determined as described herein.

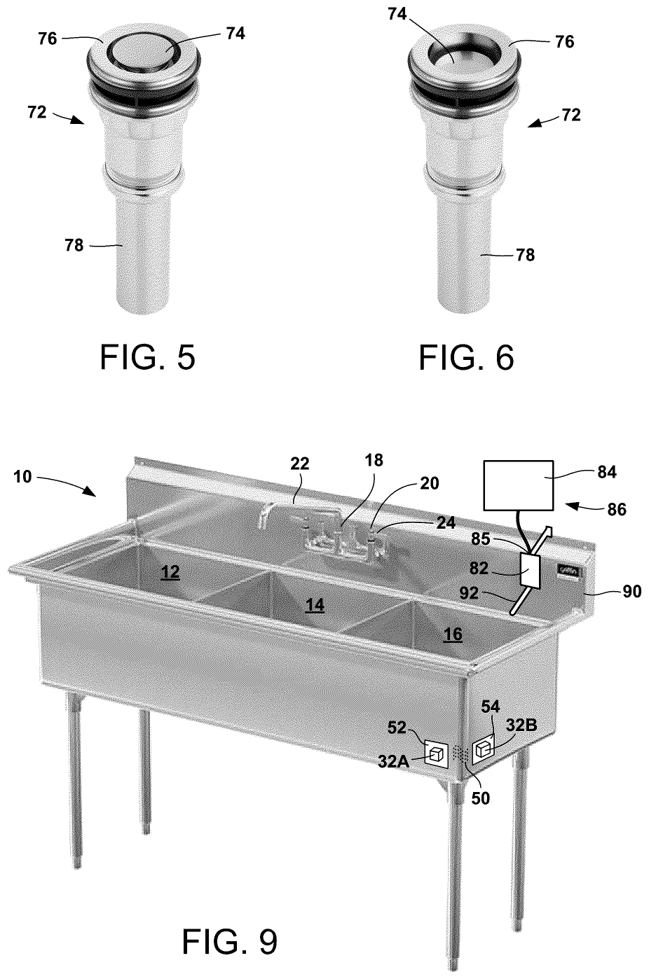

The sink basin 16 can optionally be provided with a drain interface 72, an example of which is shown in FIGS. 5 and 6, that controls the retention of the liquid sanitizing composition 42 in the sink basin 16. The drain interface 72 includes a plug 74 disposed within a surrounding collar 76 that is to be installed substantially flush with the bottom 26 of the sink basin 16, in the drain 30 (FIG. 2). The plug 74 is in an extended condition in FIG. 5, where the plug 74 interferes with the flow of the liquid sanitizing composition 42 from the sink basin 16 through the drain 30. In FIG. 6, the plug 74 is in a recessed condition, where the plug 74 has been adjusted in a direction generally toward the drain, to allow the liquid sanitizing composition 42 to flow from the sink basin 16 through the drain 30 to be evacuated from the sink basin 16. The concentration of the sanitizer in the liquid sanitizing composition 42 for use in the food service industry is sufficiently low that the liquid sanitizing composition 42 can be drained into a public sewer system, or other disposal destination.

An actuator 78 is suspended beneath the collar 76, to be inserted into the drain 30 when the drain interface 72 is fully installed. The actuator 78 can be any device that is operable under the control of the electronic control circuitry 62 to adjust the plug 74 between the extended condition and the recessed condition. For example, the actuator 78 can be a mechanical, electro-mechanical, electrical or other linear actuator that utilizes a DC motor, electromagnet, electric cylinder or other device operable by the electronic control circuitry 62 to move the plug 74 in linear directions between the extended and recessed conditions.

The electronic control circuitry 62 described above can be operatively connected to the actuator 78 to automatically control the position of the plug 74 to drain the liquid sanitizing composition 42 from the sink, when appropriate. For example, the timer circuit 70 can issue a drain signal in response to expiration of a period of time, such as 4 hours, for example. After 4 hours, the liquid sanitizing composition 42 is deemed to have reached the end of its useful life to the possible introduction of contaminants during that time. In response to receiving the drain signal transmitted by the timer circuit 70, the actuator 78 can adjust the plug 74 to the recessed condition, opening the drain interface 72 to thereby open the drain 30, allowing the liquid sanitizing composition 42 to be evacuated from the sink basin 16. After another period of time has expired, as determined by the timer circuit 70, the timer circuit can transmit a close signal, causing the actuator 78 to return the plug 74 to the extended condition. According to other embodiments, the apparatus 32, multi-sink cleansing station 10, drain interface 72 or other object can be provided with a manual return interface that is to be manipulated by the user to return the plug 74 to the extended condition.

According to alternate embodiments, the electronic control circuitry 62 can optionally include interface circuitry 80 that operatively connects the apparatus 32 to remotely-located implements. For example, the interface circuitry 80 can transmit signals that control operation of a dispenser interface 82 (FIG. 9) in fluid communication with a reservoir 84 (FIG. 9) storing the sanitizer, to introduce a quantity of the sanitizer from the reservoir 84 to the liquid sanitizing composition 42. For example, the dispenser interface 82 can include an intake 85 through which the sanitizer is fed from the reservoir 84 through the force of gravity, as a result of a vacuum generated by a pump 87 (FIG. 11) that draws the sanitizer from the reservoir 84, etc., into the dispenser interface 82. The dispenser interface 82 can include control circuitry that, responsive to signals transmitted by the interface circuitry 80, introduces a quantity of the sanitizer to the liquid sanitizing composition 42. Adding the quantity of the sanitizer from the reservoir 84 increases the concentration of the sanitizer in the liquid sanitizing composition 42 from the concentration immediately before the quantity of sanitizer was added. In response to the electronic control circuitry 62 determining that the sensed concentration of the sanitizer in the liquid sanitizing composition 42 has fallen below a defined threshold value as described herein, the interface circuitry 80 can transmit a signal causing the sanitizer to be introduced from the reservoir 84 to the liquid sanitizing composition 42.

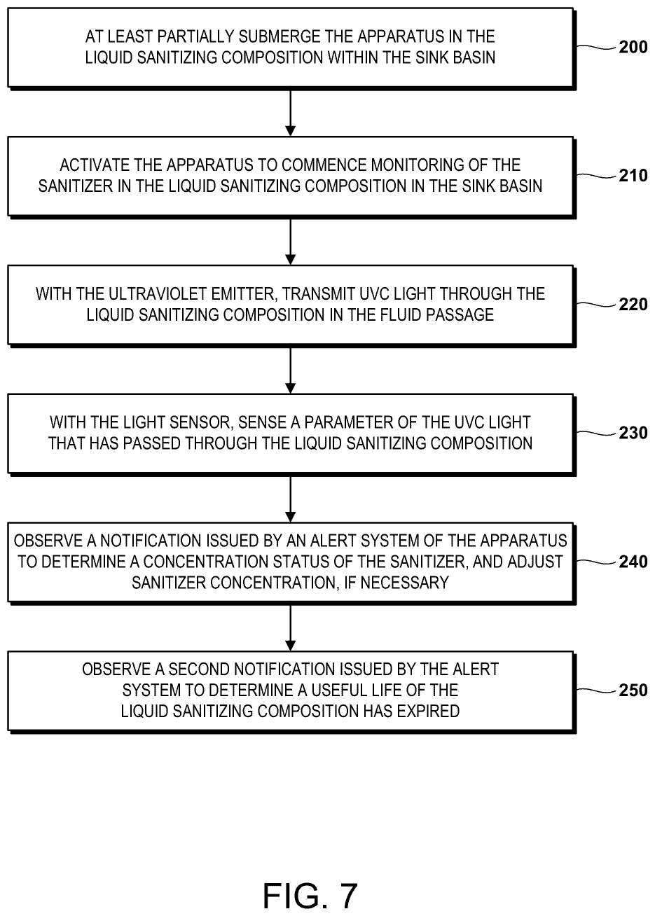

FIG. 7 shows a flow diagram schematically depicting an embodiment of a process for monitoring a concentration of a sanitizer in the liquid sanitizing composition 42. According to the illustrated embodiment, a user such as a dishwasher, food service manager, or other kitchen personnel can at least partially submerge the apparatus 10 in the liquid sanitizing composition 42 within the sink basin 16 at step 200. Submerging the apparatus 10 in the liquid sanitizing composition 42 can include placing the apparatus 10 right-side-up in the empty sink basin 16 and then adding water and/or the sanitizer to the sink basin 16, or at least partially filling the sink basin 16 with the combination of water and the sanitizer. A suitable quantity of the sanitizer can be combined with the water in the sink basin 16 to achieve a suitable concentration of the sanitizer for sanitizing wares for the food service industry. For example, the target concentration of the sanitizer in the liquid sanitizing composition 42 can be within a range from about 200 ppm to about 300 ppm, for example. Due at least in part to such a small range of concentrations, it is desirable to actively monitor the concentration of the sanitizer over a period of time such as the useful life of the liquid sanitizing composition 42 in the sink basin 16, for example.

The illustrative process can include activating the apparatus 10 at step 210 to commence monitoring of the concentration of the sanitizer. Activation can be caused by the user manually manipulating the input device 60, automatically as a result of the conductive pathway being established By activating the apparatus 10, the user causes the apparatus to continuously, occasionally, or periodically determine a sensed concentration of the sanitizer in the liquid sanitizing composition 42. For example, the user can cause the apparatus 10 to initiate the timer circuit 70 to take a sample of the sanitizer concentration every three (3) to ten (10) minutes, or any other interval. To take each sample, the apparatus 10 emits the UVC light 50 from the ultraviolet emitter 48 through the liquid sanitizing composition 42 within the fluid passage 36 at step 220, where the sanitizer in the liquid sanitizing composition 42 at least partially attenuates the UVC light 50. With the light sensor 46, the user can sense a parameter of the UVC light 50 at step 230 such as an intensity of the UVC light 50 reaching the light sensor 46, for example, that is indicative of the concentration of the sanitizer in the liquid sanitizing composition 42.

The user can monitor the alert system 38 of the apparatus 10 to determine a concentration status of the sanitizer in the liquid sanitizing composition 42 at the time of the sample at step 240. For example, the if the sensed concentration of the sanitizer is within the suitable range from about 200 ppm to about 300 ppm, a green LED of the LED module 40 labeled “Target” can be illuminated, assuring the user that the sensed concentration of the sanitizer is suitable for use in sanitizing wares for food service. Reassured that the sensed concentration of the sanitizer is within the acceptable range, the user can continue sanitizing wares for food service in the liquid sanitizing composition 42 without adjusting the concentration of the sanitizer.

As another example, if the sensed concentration of the sanitizer is lower than the suitable range of concentrations (from about 200 ppm to about 300 ppm in the present example), a red LED of the LED module 40 labeled “Under” can be illuminated. Based on such a notification, the observer is made aware of the condition that the sensed concentration of the sanitizer in the liquid sanitizing composition 42 is too low for properly sanitizing wares for food service. The observer can then optionally conduct a more-precise test of the sanitizer concentration to determine the quantity of sanitizer to be introduced, or simply titrate the introduction of the sanitizer to return the sanitizer concentration to a value within the suitable range of concentrations for food service.

As yet another example, if the sensed concentration of the sanitizer is above the suitable range of concentrations (from about 200 ppm to about 300 ppm in the present example), a red LED of the LED module 40 labeled “Over” can be illuminated. Based on such a notification, the observer is made aware of the condition that the sensed concentration of the sanitizer in the liquid sanitizing composition 42 is too high for use in preparing wares for food service. The observer can then optionally conduct a more-precise test of the sanitizer concentration to determine the quantity of water to be introduced, or simply titrate the introduction of water to return the sanitizer concentration to a value within the suitable range of concentrations for food service.

According to alternate embodiments, if the sensed concentration of the sanitizer based on the attenuation of the UVC light 50 is determined to be above the suitable range of concentrations (from about 200 ppm to about 300 ppm in the present example), an additional sample can optionally be taken by the apparatus 10 and factored into the notification that is issued by the alert system 38. For example, embodiments of the apparatus 10 can also transmit UVA light 57, for example, using the second emitter 56 and sense the intensity or other parameter of the UVA light 57 passing through the liquid sanitizing composition 42 with the second light sensor 64. Based on the sensed parameter of the UVA light 57, the electronic control circuitry 62 can determine the sanitizer concentration and compare the determination result based on the UVA light 57 to the determination result based on the UVC light 50. If the attenuation of the UVC light 50 is out of range (suggesting the sanitizer concentration is greater than the suitable range), and if the sensed parameter of the UVA light 57 is also out of range (indicating that the sanitizer concentration is greater than the suitable range), a red LED of the LED module 40 labeled “Over” can be illuminated. If however, the determination result based on the UVA light 57 is in range (indicating that the sanitizer concentration is actually within the suitable range), then the electronic control circuitry 62 can determine that the determination result based on the UVC light 50 is skewed by the optical clarity of the liquid sanitizing composition 42. As a result, the green LED of the LED module 40 labeled “Target” can be illuminated, despite the determination result based on the UVC light 50.

Use of the apparatus by the user can also involve observing a second notification issued by the alert system 38 of the apparatus 32 to determine that the useful life of the liquid sanitizing composition 42 in the sink basin 16 has expired at step 250. For example, if the timer circuit 70 indicates that four (4) hours have passed since the apparatus 32 was activated, the alert system 38 can issue a notification that is different from notifications concerning the concentration of the sanitizer. For example, a plurality, or all of the LEDs provided to the LED module 40 can be illuminated, or illuminated in a unique pattern, causing the observer to drain the liquid sanitizing composition 42 from the sink basin 16, and replace it with a fresh batch of the liquid sanitizing composition 42. Again, introducing the fresh batch of the liquid sanitizing composition 42 into the sink basin 16 can involve introducing a concentrated sanitizer into the sink basin 16, and diluting the concentrated sanitizer with water to a concentration with the range of concentrations suitable to sanitize the wares for food service.

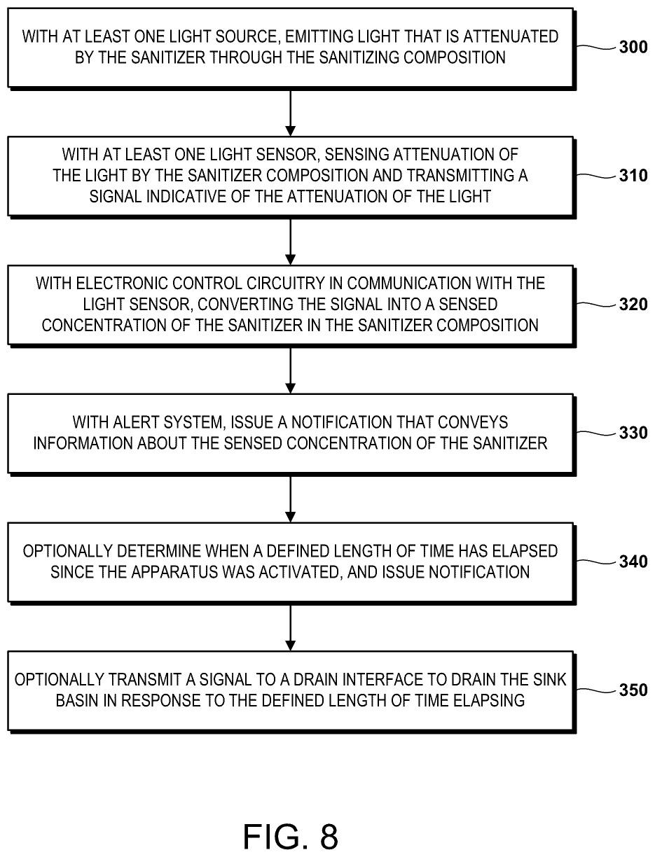

The electronic control circuitry 62 can include discrete electronic components, a microprocessor programmed with computer executable logic, or any other configurable circuit components to perform a method of monitoring sanitizer concentration. FIG. 8 shows steps included in an illustrative embodiment of such a control method for monitoring the concentration of a sanitizer in a liquid sanitizing composition 42, as described herein using quat as the sanitizer diluted in water to collectively form the liquid sanitizing composition 42. Additional contaminants or other substances may be present in the liquid sanitizing composition 42, but will be omitted from the present discussion for the sake of brevity. As shown in FIG. 8, once the apparatus 32 is activated the electronic control circuitry 62 can control operation of the ultraviolet emitter 48 to emit UVC light 50, at step 300, that is attenuated by the quat mixed with the water in the fluid passage 36. Activation can occur in response to the electronic control circuitry 62 receiving an “on” signal transmitted as a result of at least one of: (i) manipulation of the input device 60, (ii) actuation of a fluid-activated switch when the quat-water composition submerges at least a portion of both electrodes 68, and any other condition indicating when monitoring of the quat concentration is desired.

At step 310, the light sensor 46 senses the UVC light 50 that has been attenuated by the quat after the UVC light 50 has passed through the quat-water combination. The light sensor 46 can detect an intensity or any other property of the attenuated UVC light 50, and transmit a signal indicative of the attenuation of the UVC light 50 attributed to the quat based on that sensed property.

The electronic control circuitry 62 in communication with the light sensor 46 converts the signal transmitted by the light sensor 46 into a sensed concentration of the quat in the quat-water combination at step 320. For example, the electronic control circuitry 62 can optionally apply a linear model relating quantitative values (e.g., magnitude or amplitude of voltage or amperage, frequency, etc.) of the signal transmitted by the light sensor 46, which represents the sensed attenuation of the UVC light 50 attributed to the quat, to concentration values of the quat.

Based on the sensed concentration, the electronic control circuitry 62 can control operation of the alert system 38, to issue a notification that conveys information about the sensed concentration of the quat at step 330. As described in detail above, the notification can include at least one of a visible notification, an audible notification, and a visible and audible notification indicating whether the quat concentration is within a suitable range (e.g., from about 200 ppm to about 300 ppm in the present example). For example, the green LED of the LED module 40 labeled “Target” can be illuminated if the sensed quat concentration is within the suitable range, the red LED of the LED module 40 labeled “Over” can be illuminated if the sensed quat concentration is greater than the suitable range, and the red LED of the LED module 40 labeled “Under” can be illuminated if the sensed quat concentration is less than the suitable range.

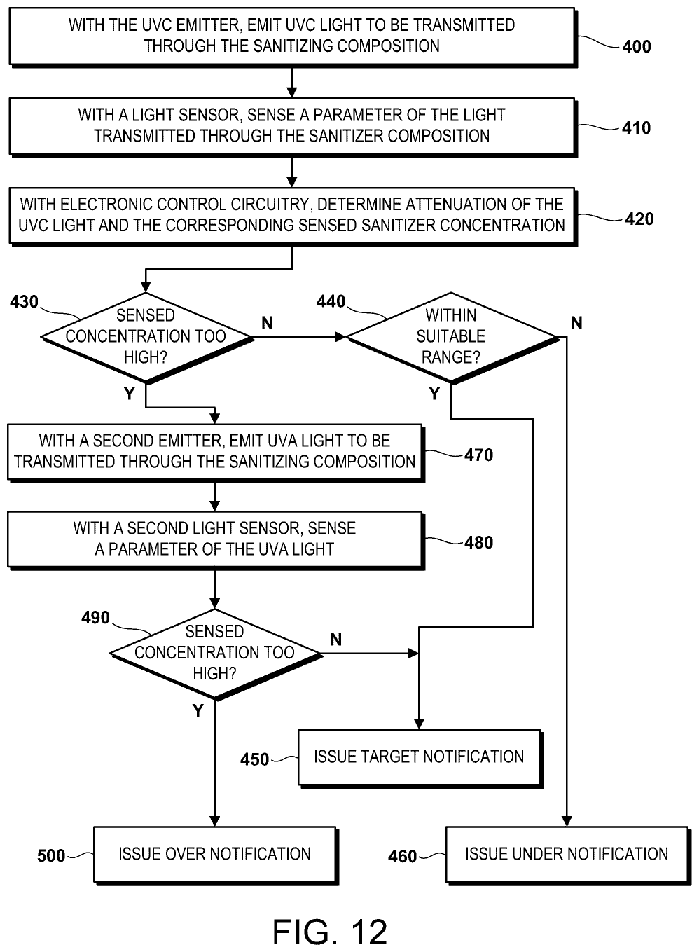

Some embodiments of the above process can account for reduced optical clarity of the liquid sanitizing composition 42 that could potentially cause the electronic control circuitry 62 to erroneously determine that the sanitizer concentration is higher than it actually is. An illustrative embodiment of such a process is depicted by the flow diagram in FIG. 12, which provides details of steps 300, 310, 320 and 330 in the process represented in FIG. 8. For example, UVC light 50 can be emitted by ultraviolet emitter 48 and transmitted through the liquid sanitizing composition 42 in the fluid passage 36 at step 400 in FIG. 12. The light sensor 46 can sense a parameter such as the intensity of the UVC light 50 that reaches the light sensor 46 after passing through the liquid sanitizing composition 42 at step 410, and transmits a signal indicative of that sensed parameter.

The electronic control circuitry 62 determines the attenuation of the UVC light 50 and, accordingly, the sensed concentration of the sanitizer based on the signal transmitted by the light sensor 46 at step 420. The attenuation can be determined by comparing the intensity of the UVC light 50 transmitted by the ultraviolet emitter 48 to the intensity of the UVC light 50 sensed by the light sensor 46, for example. At step 430, the electronic control circuitry 62 determines whether the sensed concentration of the sanitizer based on the attenuation of the UVC light 50 is less than the upper limit of the suitable range of concentrations. If so, the electronic control circuitry 62 determines whether the sensed concentration is within the suitable range at step 440. If the sensed concentration is within the suitable range a green LED of the LED module 40 labeled “Target” can optionally be illuminated at step 450. If the sensed concentration is less than the suitable range of concentrations, the electronic control circuitry 62 can illuminate a red LED of the LED module 40 labeled “Under” at step 460.

If, however, the electronic control circuitry 62 determines at step 430 that that the sensed concentration of the sanitizer is greater than the suitable range of concentrations based on the attenuation of UVC light 50, the electronic control circuitry 62 determines if the sensed concentration is truly above the suitable range, or an erroneous reading possibly attributable to the optical clarity of the liquid sanitizing composition 42. At step 470 the second emitter 56 can emit a different wavelength of light such as the UVA light 57, which is transmitted through the liquid sanitizing composition 42. At step 480 a parameter such as the intensity of the UVA light transmitted through the liquid sanitizing composition 42, and optionally filtered by the region 59 of the second shield 54, is sensed by the second light sensor 64. The electronic control circuitry 62 determines the sensed concentration of the sanitizer based on the parameter of the UVA light 57 sensed by the second light source 64 and determines whether that sensed concentration is greater than the suitable range at step 490.

If the sensed concentration is greater than the upper limit of the suitable range of concentrations, the electronic control circuitry 62 can illuminate a red LED of the LED module 40 labeled “Over” at step 500. The sensed concentration of the sanitizer is determined to be greater than the upper limit of the suitable range based on both the UVC light 50 attenuation and the UVA light 57 attenuation. Accordingly, the elevated sanitizer concentration is not attributed to the optical clarity of the liquid sanitizing composition 42.

If, however, the electronic control circuitry 62 determines at step 490 that the sensed concentration is within the suitable range, a green LED of the LED module 40 labeled “Target” can be illuminated at step 450. The green LED labeled “TARGET” can be illuminated under the control of the electronic control circuitry 62 despite the previous determination that the sensed concentration exceeds the upper limit of the suitable range at step 430 based on the UVC light 50. In view of the determination at step 490 based on attenuation of the UVA light 57, the elevated sensed concentration of the sanitizer based on attenuation of the UVC light 50 is attributed to degraded optical clarity of the liquid sanitizing composition 42, and overridden based on the determination based on attenuation of the UVA light 57.

Any of the processes can optionally be repeated upon demand by a user, occasionally, or at regular periodic intervals. For example, upon each expiration of a period of time (e.g., every four (4) minutes) as determined by the timer circuit 70, the light sensor 46 can detect the attenuation of the UVC light 50. The plurality of signals corresponding to the sensed attenuation values for the UVC light 50 at each interval can be converted by the electronic control circuitry 62 and used to control operation of the alert system 38 as described herein.

Further, the timer circuit 70 can optionally determine when a defined amount of time corresponding to the useful life of the quat-water combination has elapsed since the apparatus 32 was introduced to that combination and activated, at step 340. According to some embodiments, after the useful life has expired the electronic control circuitry 62 controls the alert system 38 to issue a replenish notification to indicate when the quat-water composition is to be replenished. According to other embodiments, after the useful life has expired the electronic control circuitry 62 can transmit a drain signal, at step 350, that controls the drain interface 72 provided to the sink basin 16, causing the drain 30 of the sink basin 16 to open and allow the quat-water composition to be drained from the sink basin 16.

The present disclosure describes the electronic control circuitry 62 determining properties of the liquid sanitizing composition 42 based on signals transmitted by the light sensor 46, and optionally the second light sensor 64, for the sake of clarity and brevity. However, references to signals transmitted by the light sensor 46, second light sensor 64, and any other sensor or component herein also encompasses derivatives of those transmitted signals. A voltage, current, frequency, or other electrical property resulting from the output of the light sensor 46, second light sensor 64 or any other component is considered to be within the scope of a signal transmitted by the respective light sensor 46, second light sensor 64 or other component. For example, if the actual output of the light sensor 46 is used to bias a transistor into a conductive mode to deliver a DC voltage from the power source 58 to the electronic control circuitry 62, that DC voltage is considered to be a signal transmitted by the light sensor 46. And based on that DC voltage, for example, the electronic control circuitry 62 can determine the sensed concentration of the sanitizer in the liquid sanitizing composition 42, and control operation of the alert system 38 as described herein. But again, the present disclosure describes the use of a signal transmitted by the light sensor 46 to succinctly encompass all such scenarios rather than delving into a detailed description of every possible source of the signal that is actually used to determine the sensed concentration of the sanitizer, and possibly other properties of the liquid sanitizing composition 42.

An alternate embodiment of the apparatus 32 is shown in FIG. 9. As mentioned above, the electronic control circuitry 62 can optionally include interface circuitry 80 that operatively connects the apparatus 32 to remotely-located implements such as the sanitizer system 86. The sanitizer system 86 can include a clip 88 that allows the sanitizer system 86 to be suspended from a backsplash 90 of the multi-sink cleansing station 10, for example. According to alternate embodiments, the sanitizer system 86 can be installed on a wall, rest on the ground near the multi-sink cleansing station 10, or placed anywhere else where it can dispense the sanitizer from the reservoir 84. In response to receiving a signal from the electronic control circuitry 62, the dispenser interface 82 is operable to meter suitable quantities of the sanitizer from the reservoir 84 into the liquid sanitizing composition 42 in the sink basin 16, thereby increasing the sanitizer concentration assuming additional water or other liquids are not added. The metered sanitizer can be delivered into the sink basin 16 through an optional conduit 92. According to such embodiments, the sanitizer concentration can be automatically maintained to limit the possibility that the sanitizer concentration drops below the suitable range for the particular application.

Also shown in FIG. 9 is an illustrative embodiment of the apparatus 32 that forms a portion of at least one sink basin 16 of the multi-sink cleansing station 10. According to the illustrated embodiment, the apparatus 32 is formed as two (2) separate portions, the transmitter 32A and the receiver 32B. The transmitter 32A is housed in a first housing portion and includes at least the light source 44 including the ultraviolet emitter 48 that emits the UVC light 50 (and/or other type of light), and optionally the second emitter 56. The receiver 32B is housed in a second housing portion and includes at least the light sensor 46 and optionally the second light sensor 64. Electronic control circuitry 62 is operatively connected to both the transmitter 32A and the receiver 32B to control operation of the light source 44 and the light sensor 46 in the same manner as described above. The first shield 52 and the second shield 54 form a portion of the structure defining the periphery of the sink basin 16, allowing the UVC light 50 to pass through the walls of the sink basin 16 and a portion of the liquid sanitizing composition 42 therein. The alternate embodiment of the apparatus 32 described with reference to FIG. 9 otherwise functions the same as the other embodiments described herein, so a detailed description of the functioning of the alternate embodiment is omitted for brevity.

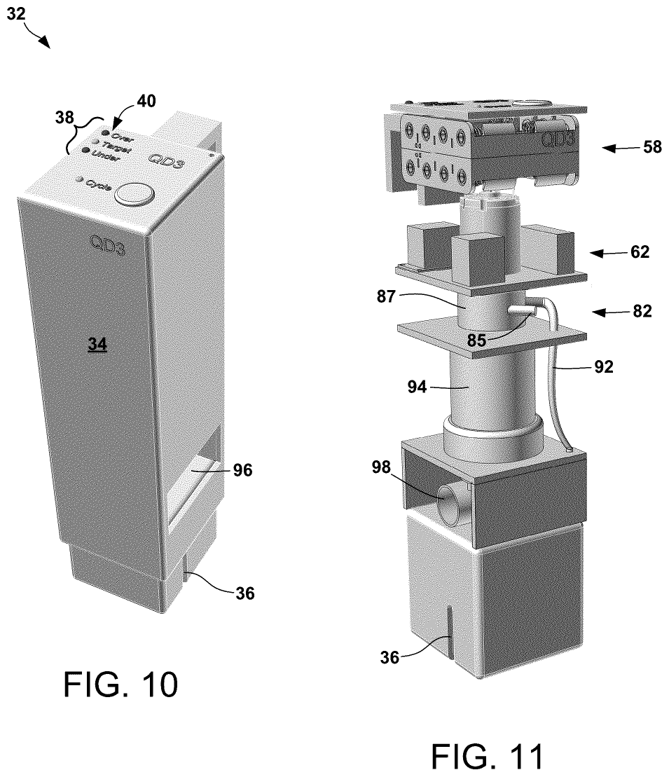

FIG. 10 shows a perspective view of another embodiment of the apparatus 32, and a perspective view of the apparatus 32 shown in FIG. 10 with an upper portion of the housing 34 removed is shown in FIG. 11. As shown, the apparatus 32 includes the embodiment of the electronic control circuitry 62 (FIG. 4) with the interface circuitry 80 (FIG. 4). The embodiment of the apparatus 32 in FIGS. 10 and 11 includes the dispenser interface 82 (FIG. 11) integrated therein, forming a portion of a common assembly that also defines the fluid passage 36 and supports the electronic control circuitry 62, for example.

According to the illustrated embodiment, the dispenser interface includes a pump 87 such as a peristaltic dosing pump, for example, that is operable to deliver small quantities of the sanitizer to the liquid sanitizing composition 42. The intake 85 can be plumbed to a reservoir 84 (FIG. 9) by inserting a suction line into the reservoir 84, or by mounting the reservoir 84 at a vertical elevation above the vertical elevation of the intake 85 and allowing the sanitizer to be biased toward the intake 85 under the force of gravity. Control circuitry, which can optionally be included as part of the electronic control circuitry 62 that controls operation of the apparatus 32 in the present embodiment, selectively activates the pump 87 to add sanitizer to the liquid sanitizing composition 42. For example, in response to a determination by the electronic control circuitry 62 that the sanitizer concentration has fallen below the suitable range and transmission of a corresponding signal by the electronic control circuitry 62, the control circuitry of the dispenser interface 82 energizes the pump 87. The pump can be activated for a length of time to deliver an amount of the sanitizer to the liquid sanitizing composition 42 suitable to bring the sanitizer concentration back into the suitable range.

The sanitizer being introduced to the liquid sanitizing composition 42 can optionally first be mixed with a portion of the liquid sanitizing composition 42 by a circulating pump 94. Liquid sanitizing composition 42 can be drawn into a pump intake 96 (FIG. 10) and mixed with the sanitizer delivered through the conduit 92 before being expelled through a nozzle or outer suitable outlet port 98. The flow of the liquid sanitizing composition 42 from the outlet port 98 also serves to promote uniform distribution of the sanitizer throughout the liquid sanitizing composition 42 in the sink basin 16. As a result, the liquid sanitizing composition 42 present within the fluid passage 36 used to determine the concentration of the sanitizer is likely to yield a result that is representative of the bulk liquid sanitizing composition 42 in the sink basin 16.

The embodiments of the apparatus 32 shown in FIGS. 10 and 11 can include a cycle input 96. The cycle input 96 is operatively connected to the electronic control circuitry 62 to initiate a cycle process in response to being manipulated. For example, the cycle input 96 can include a pushbutton that, when pushed by a user causes the electronic control circuitry 62 to transmit a signal to the drain interface 72 (FIGS. 5 and 6), causing the liquid sanitizing composition 42 to be drained from the sink basin 16 (FIG. 1). According to alternate embodiments, manipulation of the cycle input 96 can cause the electronic control circuitry 62 to activate the circulating pump 94 (FIG. 11) and introduce the sanitizer from the reservoir 84 into the sink basin 16, optionally after causing the liquid sanitizing composition 42 to be drained from the sink basin 16. According to yet other embodiments, manipulation of the cycle input 96 can cause the electronic control circuitry 62 to activate the circulating pump 94 to mix the liquid sanitizing composition 42 as part of a sampling process during which the concentration of the sanitizer is to be monitored as described herein.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

1. An apparatus that monitors a concentration of a component in a liquid composition, the apparatus comprising:
a housing that defines a fluid passage that receives the liquid composition when the apparatus is at least partially submerged in the liquid composition;
a light source supported by the housing that emits light that is attenuated by the component in the liquid composition;
a light sensor supported by the housing a first distance from the light source, at a position separated from the light source by the fluid passage, wherein the light sensor senses attenuation of the light by the component within the fluid passage and transmits a signal indicative of the attenuation of the light;
electronic control circuitry operatively connected to the light sensor to receive the signal and convert the signal into a sensed concentration of the component in the liquid composition; and
an alert system that is activated by the electronic control circuitry to issue a notification that conveys information about the sensed concentration of the component.

2. The apparatus of claim 1, wherein the housing defines the fluid passage as a through passage extending entirely through the housing to allow the liquid composition to pass through the housing while the housing is at least partially submerged within the liquid composition.

3. The apparatus of claim 2, wherein the light source and the light sensor are supported by the housing on opposite sides of the fluid passage, and the light sensor senses the attenuation of the light by the liquid composition within the fluid passage.

4. The apparatus of claim 1 further comprising an onboard power source supported by the housing that supplies electric energy and energizes the light source to emit the light, wherein the onboard power source comprises a battery in a watertight compartment of the housing, and the housing is devoid of wires protruding from the housing that connect the apparatus to a remote power source.

5. The apparatus of claim 1, wherein the light source comprises an ultraviolet emitter that emits ultraviolet-C light having a wavelength within a range from about 200 nm to about 300 nm, and the light sensor senses the attenuation of the ultraviolet-C light by the liquid composition within the fluid passage.

6. The apparatus of claim 5, wherein the housing comprises:
a first shield arranged adjacent to the light source that forms a first portion of the housing that defines the fluid passage; and
a second shield arranged adjacent to the light sensor that forms a second portion of the housing that defines the fluid passage, wherein
the first shield and the second shield are formed from a material that is substantially-transparent to ultraviolet-C light.

7. The apparatus of claim 5, wherein the light source is configured to emit a second light having a second wavelength outside of the range from about 200 nm to about 300 nm.

8. The apparatus of claim 7, wherein the second light is ultraviolet-A light having a wavelength from about 315 nm to about 400 nm, the apparatus further comprising a second light sensor that senses a presence of a contaminant in the liquid composition based on an effect of the liquid composition in the fluid passage on the ultraviolet-A light emitted by the light source.

9. The apparatus of claim 1, wherein the light emitted by the light source is attenuated by at least the component in the liquid composition, but is not attenuated by pure water.

10. The apparatus of claim 1 further comprising a fluid-activated switch that activates the apparatus in response to a portion of the apparatus being submerged in the liquid composition.

11. The apparatus of claim 10, wherein the fluid-activated switch deactivates the apparatus in response to removal of the portion of the apparatus from the liquid composition.

12. The apparatus of claim 1, wherein the alert system comprises a LED module that emits different colors of light in response to comparison results of the sensed concentration of the component in the liquid composition to different threshold values.

13. The apparatus of claim 12, wherein the LED module emits:
a first color of light in response to the sensed concentration of the component in the liquid composition falling within a range from 200 ppm to 400 ppm; and
a second color of light, that is different from the first color of light, in response to the sensed concentration of the component in the liquid composition exceeding 400 ppm.

14. The apparatus of claim 13, wherein the LED module emits a third color of light, that is different from the first color of light, in response to the sensed concentration of the component in the liquid composition being less than 200 ppm.

15. The apparatus of claim 1, wherein the alert system comprises a remote indicator that is separated from the housing, to be positioned independently of the housing, wherein the apparatus further comprises a transmitter that communicates with the remote indicator, causing the remote indicator to issue the notification that conveys information about the sensed concentration of the component.

16. The apparatus of claim 1 further comprising a drain interface operatively connected to the electronic control circuitry, wherein the electronic control circuitry comprises a timer circuit that issues a drain signal in response to expiration of a period of time, and the drain signal causes the drain interface to open a drain of a sink bay in which the housing is at least partially submerged in the liquid composition.

17. The apparatus of claim 1 further comprising a dispenser interface that is operable to selectively introduce a quantity of the component from a reservoir to the liquid composition, thereby adjusting the concentration of the component in the liquid composition.

18. An apparatus that monitors a concentration of a sanitizer in a liquid sanitizing composition used to sanitize objects, the apparatus comprising:
a housing that defines a fluid passage extending entirely through the housing to allow the liquid sanitizing composition to flow through the housing while the housing is at least partially submerged within the liquid sanitizing composition;
an onboard power source supported by the housing that supplies electric energy, wherein the housing is devoid of an external power connection to receive external electric energy from a remote power source;
a light source supported by the housing adjacent to the fluid passage that is energized by the electric energy supplied by the onboard power source to emit:
ultraviolet light having a first wavelength within a first ultraviolet range of wavelengths that is attenuated by the sanitizer in the sanitizing composition, and
light having a second wavelength that is outside of the first ultraviolet range of wavelengths, wherein the light having the second wavelength is affected by a contaminant in the sanitizing composition, wherein the contaminant is different from the sanitizer;
a light sensor supported by the housing a fixed distance from the light source, at a position separated from the light source by the fluid passage, wherein the light sensor senses:
attenuation of the ultraviolet light having the first wavelength by the sanitizer composition within the fluid passage and transmits a first signal indicative of the attenuation of the light, and
an effect the contaminant in the sanitizer composition within the fluid passage has on the light having the second wavelength, and transmits a second signal indicative of the effect the contaminant has on the light having the second wavelength;
electronic control circuitry operatively connected to the light sensor to receive the first signal and the second signal, and convert the first signal and the second signal into a sensed concentration of the sanitizer in the sanitizer composition; and
an alert system that is activated by the electronic control circuitry to issue a notification that conveys information about the sensed concentration of the sanitizer, wherein the notification comprises at least one of a visible notification and an audible notification.

19. The apparatus of claim 18, wherein the light source comprises an ultraviolet emitter that emits:
the ultraviolet light as ultraviolet-C light; and
the light having the second wavelength as ultraviolet-A light.

20. The apparatus of claim 18, wherein the alert system comprises a LED module that emits different colors of light in response to comparison results of the sensed concentration of the sanitizer in the sanitizer composition to different threshold values, wherein the LED module emits at least:
a first color of light in response to the sensed concentration of the sanitizer in the sanitizer composition falling within a range from 200 ppm to 400 ppm, and
a second color of light, that is different from the first color of light, in response to the sensed concentration of the sanitizer in the sanitizer composition exceeding 400 ppm, and
a third color of light, that is different from the first color of light, in response to the sensed concentration of the sanitizer in the sanitizer composition being less than 200 ppm.
